(19) United States
(12) Patent Application Publication
(10) Pub. No.: US 2023/0361498 A1
(43) Pub. Date: Nov. 9, 2023

(54) CONNECTOR

(71) Applicant: SUMITOMO WIRING SYSTEMS, LTD., Mie (JP)

(72) Inventor: Sho SAITO, Mie (JP)

(21) Appl. No.: 17/795,324

(22) PCT Filed: Jan. 8, 2021
(86) PCT No.: PCT/JP2021/000462

§ 371 Date: Jul. 26, 2022

(30) Foreign Application Priority Data
Jan. 29, 2020 (JP) 2020-012586

(51) Int. Cl. H01R 13/426; H01R 13/428; H01R 24/40

(52) U.S. Cl. CPC H01R 13/426; H01R 13/428; H01R 24/40

(57) ABSTRACT

A housing (10) includes a cavity (14) extending in a front-rear direction and a deflectable locking lance (15) projecting forward and facing the cavity (14). The housing (10) includes an opening (25) communicating with the cavity (14) in a side surface of the housing (10) located laterally to the cavity (14). The locking lance (15) includes a locking portion (16) capable of locking a terminal fitting (60) and a release receiving portion (18) in the form of a projecting piece including a front end of the locking lance (15). A side surface part of the release receiving portion (18) is visually confirmable on a side surface side of the housing (10) via the opening (25).

### TECHNICAL FIELD

The present disclosure relates to a connector.

### BACKGROUND

A connector disclosed in Patent Document 1 is provided with a housing and a terminal fitting. The housing includes a terminal insertion portion (hereinafter, a cavity) extending in a front-rear direction and a deflectable locking lance projecting forward and facing the cavity. The terminal fitting is inserted into the cavity of the housing from behind. The locking lance includes a locking projection on a front end part. The terminal fitting is locked by the locking projection of the locking lance and retained in the housing.

The housing includes a pair of left and right curved portions forming a front part of the cavity. A vertical space between the both curved portions is formed according to a movement of a mold for forming a front surface part of the locking projection. Thus, the front surface part of the locking projection is visually confirmable on a front surface side of the housing via the space between the both curved portions. A structure for locking a terminal fitting by a locking lance and retaining the terminal fitting in a housing is also disclosed in Patent Document 2.

### PRIOR ART DOCUMENT

### Patent Document

Patent Document 1: JP 2018-120687 A
Patent Document 2: JP 2019-106278 A

### SUMMARY OF THE INVENTION

### Problems to be Solved

In the case of Patent Document 1, a front part of the terminal fitting is supported by the pair of left and right curved portions. However, since the space is present between the both curved portions, a supporting force is reduced accordingly. Further, a front stop function of stopping the insertion of the terminal fitting cannot be exhibited in the space between the both curved portions.

On the other hand, in pulling out the terminal fitting from the cavity, a part (part in the form of a projecting piece) of the locking lance forward of the locking projection is pressed by a jig to release the locking of the locking projection and the terminal fitting. The jig is inserted into between the pair of curved portions from the front surface side of the housing.

Here, to stably support the terminal fitting and exhibit the front stop function for the terminal fitting, another member may be inserted into between the both curved portions to close the space. However, if the other member is inserted between the both curved portions, the jig cannot be inserted into between the both curved portions when the terminal fitting is pulled out. Thus, the other member has to be removed and an operation is cumbersome.

Accordingly, the present disclosure aims to provide a connector in which a terminal fitting can be stably arranged in a cavity and the locking of a locking lance can be smoothly released.

### Means to Solve the Problem

The present disclosure is directed to a connector with a terminal fitting and a housing, wherein the housing includes a cavity extending in a front-rear direction and a deflectable locking lance projecting forward and facing the cavity, the terminal fitting is arranged in the cavity, the housing includes an opening communicating with the cavity in a side surface of the housing located laterally to the cavity, the locking lance includes a locking portion capable of locking the terminal fitting and a release receiving portion in the form of a projecting piece including a front end of the locking lance, and a side surface part of the release receiving portion is visually confirmable on a side surface side of the housing via the opening.

### Effect of the Invention

According to the present disclosure, it is possible to provide a connector in which a terminal fitting can be stably arranged in a cavity and the locking of a locking lance can be smoothly released.

### BRIEF DESCRIPTION OF THE DRAWINGS

FIG. 1 is a section of a connector of one embodiment.

FIG. 2 is an enlarged section of a part where a terminal fitting is arranged in a cavity in FIG. 1.

FIG. 3 is an enlarged back view of a cavity part of a housing.

FIG. 4 is an enlarged front view of the cavity part of the housing.

FIG. 5 is an enlarged perspective view of the housing viewed laterally.

### DETAILED DESCRIPTION TO EXECUTE THE INVENTION

### Description of Embodiments of Present Disclosure

First, embodiments of the present disclosure are listed and described.

(1) The connector of the present disclosure is provided with a terminal fitting and a housing, wherein the housing includes a cavity extending in a front-rear direction and a deflectable locking lance projecting forward and facing the cavity, the terminal fitting is arranged in the cavity, the housing includes an opening communicating with the cavity in a side surface of the housing located laterally to the cavity, the locking lance includes a locking portion capable of locking the terminal fitting and a release receiving portion in the form of a projecting piece including a front end of the locking lance, and a side surface part of the release receiving portion is visually confirmable on a side surface side of the housing via the opening.

According to this configuration, the locking of the locking portion and the terminal fitting can be released by inserting a jig into the opening open in the side surface of the housing and pressing the release receiving portion by the jig. Thus, the locking of the locking lance can be smoothly released.

Further, the opening can be formed by moving a mold for molding a front surface side of the locking portion to a lateral side of the housing. Thus, a wall of the housing can be left in front of the locking portion, and the terminal fitting can be supported and stopped in front using the wall. As a result, the terminal fitting can be stably arranged in the cavity.

(2) Preferably, the opening has such opening dimensions that the entire side surface part of the release receiving portion is visually confirmable. According to this configuration, the jig inserted into the opening can be reliably caused to act on the release receiving portion. As a result, the reliability of an operation of releasing the locking of the locking lance can be enhanced.

(3) The housing may include a wall portion at a position in front of the locking lance and facing the locking portion, and the wall portion may have a supporting surface for supporting a front part of the terminal fitting. According to this configuration, since the front part of the terminal fitting is supported by the supporting surface of the wall portion, the terminal fitting can be prevented from being obliquely arranged in the cavity.

(4) The terminal fitting may include a tube portion having a circular cross-section and the tube portion may be covered over an entire circumference by the supporting surface. According to this configuration, the tube portion is more stably supported with respect to the housing. A coaxial terminal can be, for example, cited as a terminal fitting including a tube portion having a circular cross-section.

### Details of Embodiment of Present Disclosure

A specific example of a connector of the present disclosure is described below with reference to the drawings. Note that the present invention is not limited to these illustrations and is intended to be represented by claims and include all changes in the scope of claims and in the meaning and scope of equivalents.

### Embodiment

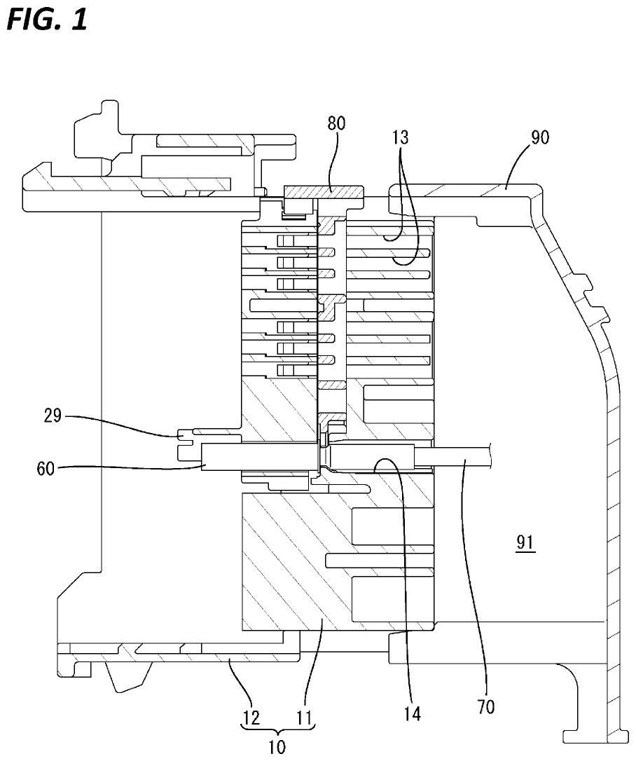

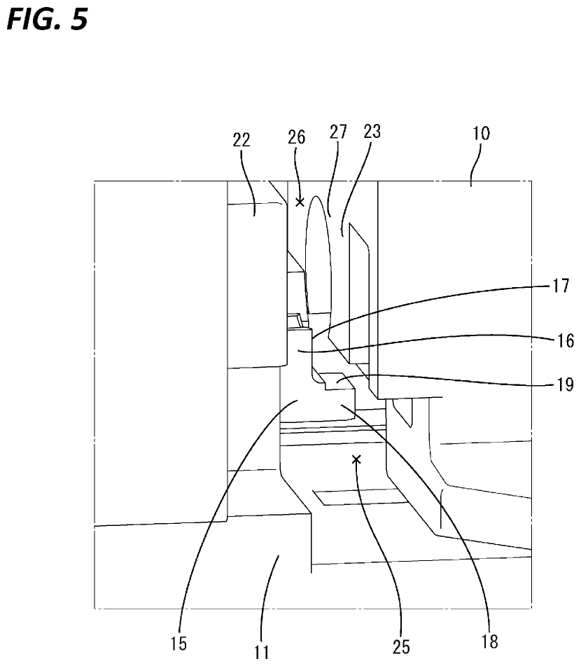

A connector of one embodiment is, as shown in FIG. 1, provided with a housing 10, a retainer 80, a wire cover 90 and a terminal fitting 60. The housing 10, the retainer 80 and the wire cover 90 are made of synthetic resin. The terminal fitting 60 is made of electrically conductive metal except a part (insulating portion 63 to be described later). Note that, in the following description, a left side of FIG. 1 is a front side concerning a front-rear direction. The front side is a side to be connected to an unillustrated mating connector. A vertical direction is based on a vertical direction of FIG. 1. Further, a lateral direction is a direction orthogonal to the front-rear direction and vertical direction and is a direction forward of the plane of FIG. 5.

The housing 10 includes a housing body 11 in the form of a block long in the vertical direction, and a tubular receptacle 12 integrally projecting forward from the outer periphery of the housing body 11.

The housing body 11 includes a plurality of general cavities 13 and one cavity 14. An unillustrated general terminal fitting is arranged in each general cavity 13. The terminal fitting 60 is arranged in the cavity 14. The general terminal fitting is a terminal not including an electrically conductive part for shielding.

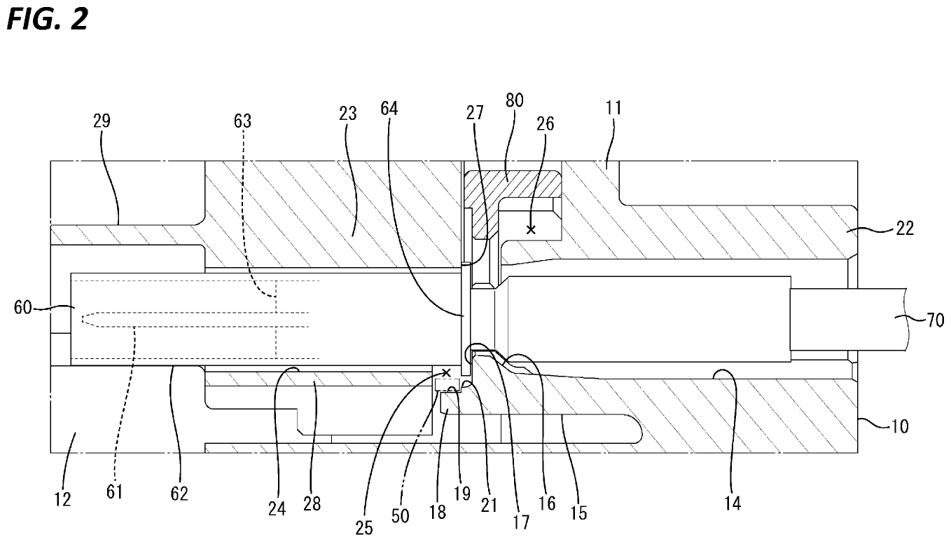

The terminal fitting 60 is a coaxial terminal to be connected to a coaxial cable (wire 70) and includes an electrically conductive part for shielding. As shown in FIG. 2, the terminal fitting 60 includes a center conductor 61, a tube portion 62 located on an outer peripheral side of the center conductor 61 and the insulating portion 63 located between the center conductor 61 and the tube portion 62. The tube portion 62 is connected to a shield part of an unillustrated mating terminal fitting. The tube portion 62 has an outer peripheral surface having a circular cross-section on a front part. A flange-like protrusion 64 is provided to protrude on the rear end of the outer peripheral surface of the tube portion 62.

As shown in FIG. 2, the housing body 11 includes a locking lance 15 cantilevered forward from the lower wall of a rear part of the cavity 14. The locking lance 15 has an upper surface part facing the cavity 14 and constituting the inner surface of the cavity 14. A locking portion 16 projecting upward (into the cavity 14) is provided on a front end part of the locking lance 15. The front surface of the locking portion 16 serves as a locking surface 17 along the vertical direction. The locking lance 15 includes a release receiving portion 18 in the form of a projecting piece projecting forward from below the locking portion 16. The release receiving portion 18 includes a front end located at a foremost position in the locking lance 15. The upper surface of the release receiving portion 18 has a receiving surface 19 flat in the front-rear direction. The receiving surface 19 of the release receiving portion 18 and the locking surface 17 of the locking portion 16 intersect at a right angle via a step portion 21.

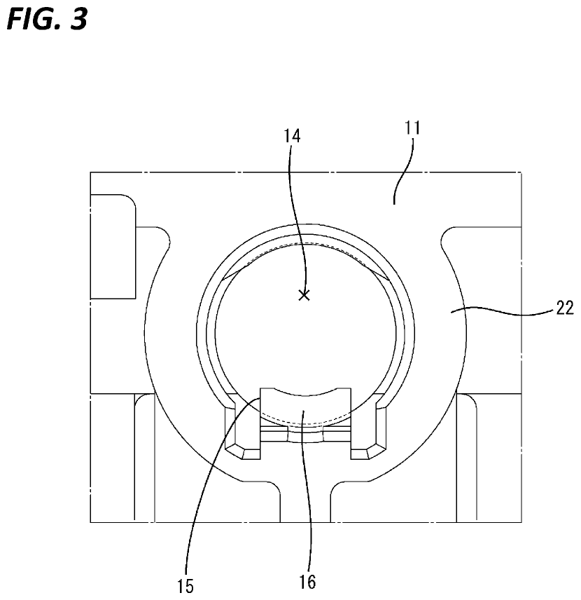

The housing body 11 includes a rear tower portion 22 along the front-rear direction in a rear part. As shown in FIG. 3, the rear tower portion 22 has a hollow cylindrical shape and the inner peripheral surface thereof defines a rear part of the cavity 14. The locking portion 16 of the locking lance 15 is exposed to a rear surface side of the housing body 11 through the inside of the rear tower portion 22 and is visually confirmable from behind.

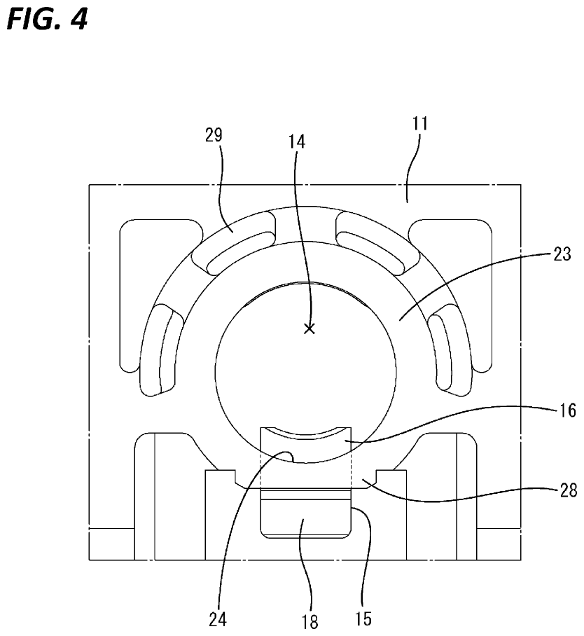

The housing body 11 includes a front tower portion 23 along the front-rear direction in a front part. As shown in FIG. 4, the front tower portion 23 has a hollow cylindrical shape and the inner peripheral surface thereof defines a front part of the cavity 14. The front tower portion 23 has a supporting surface 24 having a circular cross-section and continuous in a circumferential direction of the front tower portion 23 without interruption on an inner peripheral surface. As shown in FIG. 2, the tube portion 62 of the terminal fitting 60 is supported while being surrounded over an entire circumference by the supporting surface 24 of the front tower portion 23.

As shown in FIG. 5, the housing body 11 includes an opening 25 extending laterally and open in a side surface (side surface located laterally to the cavity 14) of the housing 11 between the front tower portion 23 and the rear tower portion 22. The opening 25 communicates with an insertion hole 26 to be described later.

The front end part of the locking lance 15 is visually confirmable on a side surface side of the housing 10 via the opening 25. In particular, side surface parts of the locking portion 16 and the release receiving portion 18 are entirely visually confirmable on the side surface side of the housing 10 via the opening 25. The side surface sides are laterally facing surfaces of the locking portion 16 and the release receiving portion 18 and orthogonal to the locking surface 17 of the locking portion 16 and the receiving surface 19 of the release receiving portion 18.

As shown in FIG. 2, a rear surface part of the front tower portion 23 is a surface facing the opening 25 and the insertion hole 26 and is a perpendicular surface upright in the vertical direction. Out of the rear surface part of the front tower portion 23, a part located above the cavity 14 is arranged behind a part located below the cavity 14 and in front of the locking surface 17 of the locking portion 16, and includes a contact stop portion 27 at a position on an opening edge part of the cavity 14.

A lower part of the front tower portion 23 is provided with a wall portion 28 along the front-rear direction. A rear surface part (part located below the cavity 14, out of the rear surface part of the front tower portion 23) of the wall portion 28 is located in front of the locking lance 15 and facing a lower part of the locking portion 16. A supporting surface 24 is also provided on the inner peripheral surface of the wall portion 28. As shown in FIG. 4, an upper part of the locking portion 16 is exposed to a front surface side of the housing 10 via a space (cavity 14) above the wall portion 28. The release receiving portion 18 projects toward the front surface side of the housing 10 via a space below the wall portion 28.

A front surface side of the front tower portion 23 is integrally connected to a part including the respective general cavities 13. As shown in FIGS. 1 and 2, a surrounding portion 29 is provided to project into the receptacle 12. The surrounding portion 29 is arranged to surround the outer peripheral surface of a front side of the tube portion 62 of the terminal fitting 60. The surrounding portion 29 projects forward from the front surface side of the front tower portion 23.

The housing body 11 includes the insertion hole 26 extending in the vertical direction and open in the upper surface and side surface of the housing body 11. The opening 25 communicates with a lower end part of the insertion hole 26. The retainer 80 is inserted into the insertion hole 26 from above the housing body 11. The retainer 80 retains the terminal fitting 60 by contacting the rear surface of the protrusion 64 of the terminal fitting 60. The retainer 80 also retains the general terminal fittings.

As shown in FIG. 1, the wire cover 90 is mounted on a rear part of the housing body 11. The wire cover 90 includes a space portion 91 for accommodating a plurality of wires 70 pulled out from the terminal fitting 60 and the respective general terminal fittings, and the respective wires 70 are drawn out downward from the wire cover 90.

Next, functions of this embodiment are described.

The terminal fitting 60 is inserted into the cavity 14 from behind. In the process of inserting the terminal fitting 60, the protrusion 64 interferes with the locking portion 16 and the locking lance 15 is deflected and deformed downward with tube portion 62 supported by the supporting surface 24 of the front tower portion 23. If the terminal fitting 60 is properly inserted into the cavity 14, the front surface of the protrusion 64 contacts the contact stop portion 27 and the insertion of the terminal fitting 60 is stopped as shown in FIG. 2. That is, the terminal fitting 60 is stopped in front. Further, if the terminal fitting 60 is properly inserted into the cavity 14, the locking lance 15 resiliently returns and the locking surface 17 of the locking portion 16 faces the rear surface of a lower part of the protrusion 64. In this way, the terminal fitting 60 is arranged in the cavity 14 of the housing body 11 while being prevented from coming out rearward. Further, by pushing and inserting the retainer 80 to a proper depth into the insertion hole 26 from the state of FIGS. 1 and 2, the retainer 80 faces the rear surface of an upper part of the protrusion 64 and the terminal fitting 60 is reliably retained.

On the other hand, in pulling out the terminal fitting 60 from the cavity 14 for maintenance or another reason, a jig 50 (see FIG. 2) is inserted into the opening 25 from a lateral side of the housing 10 after the retainer 80 is returned to the state of FIGS. 1 and 2 and the locking of the retainer 80 and the terminal fitting 60 is released. A tip part of the jig 50 is inserted into between the protrusion 64 and the release receiving portion 18 and, in that state, the receiving surface 19 of the release receiving portion 18 is pressed by the jig 50. Then, the locking lance 15 is deflected and deformed downward and the locking of the locking lance 15 and the terminal fitting 60 is released. By pulling the wire 70 rearward in that state, the terminal fitting 60 can be pulled out from the cavity 14.

As described above, according to this embodiment, the locking of the locking lance 15 and the terminal fitting 60 can be released by inserting the jig 50 into the opening 25 open in the side surface of the housing 10 and pressing the release receiving portion 18 by the jig 50. Thus, the locking of the locking lance 15 can be smoothly released.

Further, the opening 25 can be formed by moving a mold for molding a front surface side of the locking portion 16 to a lateral side of the housing 10. Thus, the wall portion 28 can be left in front of the locking portion 16, and the terminal fitting 60 can be supported using the supporting surface 24 of the wall portion 28 of the front tower portion 23. Particularly, the terminal fitting 60 can be prevented from being arranged in a state inclined downward toward the front in the cavity 14. Further, since the tube portion 62 of the terminal fitting 60 is covered over the entire circumference by the supporting surface 24 of the front tower portion 23, the tube portion 62 can be positioned by the supporting surface 24. As a result, a state where the terminal fitting 60 is stably arranged in the cavity 14 can be constructed.

Further, since the opening 25 has such opening dimensions that the entire side surface part of the release receiving portion 18 is visually confirmable, the jig 50 inserted into the opening 25 can be reliably caused to act on the release receiving portion 18 and the reliability of an operation of releasing the locking of the locking lance 15 can be enhanced.

### Other Embodiments of Present Disclosure

The embodiment disclosed this time should be considered illustrative in all aspects, rather than restrictive.

Although the terminal fitting is the coaxial terminal in the case of the above embodiment, the terminal fitting may be a general terminal fitting including no electrically conductive part for shielding as another embodiment.

Although the wall portion does not stop the terminal fitting in front in the above embodiment, the wall portion may be formed in such a shape or at such a position as to be able to stop the terminal fitting in front as another embodiment.

Although the opening communicates with the insertion hole in the case of the above embodiment, the opening may not communicate with the insertion hole and may be singly open in the side surface of the housing as another embodiment.

Although the housing includes the plurality of general cavities in the case of the above embodiment, the housing may not include the plurality of general cavities and may include only the cavity as another embodiment. In this case, the housing may accommodate only the terminal fitting (coaxial terminal in the case of the above embodiment).

### LIST OF REFERENCE NUMERALS

10 . . . housing
11 . . . housing body
12 . . . receptacle
13 . . . general cavity
14 . . . cavity
15 . . . locking lance
16 . . . locking portion
17 . . . locking surface
18 . . . release receiving portion
19 . . . receiving surface
21 . . . step portion
22 . . . rear tower portion
23 . . . front tower portion
24 . . . supporting surface
25 . . . opening
26 . . . insertion hole
27 . . . stop portion
28 . . . wall portion
29 . . . surrounding portion
50 . . . jig
60 . . . terminal fitting
61 . . . center conductor
62 . . . tube portion
63 . . . insulating portion
64 . . . protrusion
70 . . . wire
80 . . . retainer
90 . . . wire cover
91 . . . space portion

1. A connector, comprising:
a terminal fitting; and
a housing,
wherein:
the housing includes a cavity extending in a front-rear direction and a deflectable locking lance projecting forward and facing the cavity,
the terminal fitting is arranged in the cavity,
the housing includes an opening communicating with the cavity in a side surface of the housing located laterally to the cavity,
the locking lance includes a locking portion capable of locking the terminal fitting and a release receiving portion in the form of a projecting piece including a front end of the locking lance,
a side surface part of the release receiving portion is visually confirmable on a side surface side of the housing via the opening,
the housing includes a wall portion at a position in front of the locking lance and facing the locking portion,
the wall portion has a supporting surface for supporting a front part of the terminal fitting,
a protrusion is formed to project from the terminal fitting,
the housing includes a contact stop portion for stopping insertion of terminal fitting by contact with the protrusion on a surface facing the opening, and
the wall portion is arranged to extend along the front-rear direction in front of the contact stop portion.

2. A connector, comprising:
a terminal fitting; and
a housing,
wherein:
the housing includes a cavity extending in a front-rear direction and a deflectable locking lance projecting forward and facing the cavity,
the terminal fitting is arranged in the cavity,
the housing includes an opening communicating with the cavity in a side surface of the housing located laterally to the cavity,
the locking lance includes a locking portion capable of locking the terminal fitting and a release receiving portion in the form of a projecting piece including a front end of the locking lance,
a side surface part of the release receiving portion is visually confirmable on a side surface side of the housing via the opening,
the housing includes a wall portion at a position in front of the locking lance and facing the locking portion,
the wall portion has a supporting surface for supporting a front part of the terminal fitting, and
the release receiving portion projects to be visually confirmable on a front surface side of the housing via a space located on a side opposite to the cavity across the wall portion.

3. A connector, comprising:
a terminal fitting; and
a housing,
wherein:
the housing includes a cavity extending in a front-rear direction and a deflectable locking lance projecting forward and facing the cavity,
the terminal fitting is arranged in the cavity,
the housing includes an opening communicating with the cavity in a side surface of the housing located laterally to the cavity,
the locking lance includes a locking portion capable of locking the terminal fitting and a release receiving portion in the form of a projecting piece including a front end of the locking lance,
a side surface part of the release receiving portion is visually confirmable on a side surface side of the housing via the opening,
the housing includes a wall portion at a position in front of the locking lance and facing the locking portion,
the wall portion has a supporting surface for supporting a front part of the terminal fitting, the terminal fitting includes a tube portion having a circular cross-section,
the supporting surface has a circular cross-section continuous in a circumferential direction while including an inner peripheral surface of the wall portion, and
the tube portion is covered over an entire circumference by the supporting surface.

4. The connector of claim 1, wherein the terminal fitting includes a tube portion having a circular cross-section and the tube portion is covered over an entire circumference by the supporting surface.

5. The connector of claim 1, wherein the opening has such opening dimensions that the entire side surface part of the release receiving portion is visually confirmable.
